(19) United States
(12) Patent Application Publication
(10) Pub. No.: US 2025/0148552 A1
(43) Pub. Date: May 8, 2025

(54) CONSTRUCTION TIME USE OF ELEVATORS

(71) Applicant: KONE Corporation, Helsinki (FI)

(72) Inventors: Janne ÖFVERSTEN, Helsinki (FI); Tommi LOUKAS, Helsinki (FI); Ville PIIRAINEN, Helsinki (FI); Jussi-Pekka PARTANEN, Helsinki (FI); Jaakko RANNE, Helsinki (FI)

(73) Assignee: KONE Corporation, Helsinki (FI)

(21) Appl. No.: 19/013,871

(22) Filed: Jan. 8, 2025

Related U.S. Application Data
(63) Continuation of application No. PCT/EP2022/072581, filed on Aug. 11, 2022.

(51) Int. Cl. G06Q 50/08; B66B 1/34; B66B 3/00; B66B 5/00

(52) U.S. Cl. CPC G06Q 50/08; B66B 1/3446; B66B 3/002; B66B 5/0006

(57) ABSTRACT

According to an aspect, there is provided an apparatus for construction time use of at least one elevator car of an elevator system. The apparatus includes a first communication interface configured to provide a connection to at least one local construction site data source, wherein the at least one local construction site data source is configured to track people and/or material flow during the construction time use; a second communication interface configured to provide a connection to at least one site manager application configured to access data provided by the apparatus, and at least one back-end system configured to provide construction project data associated with a construction site. The apparatus is configured to monitor and/or control a construction time use of at least one elevator car based on data obtained via the first communication interface and the second communication interface.

### BACKGROUND

Elevators may be used in a building construction phase and traffic profiles of the elevators may change daily. In the constructions phase, the elevators are used primarily for construction material and equipment transport. In the construction time use (CTU), the elevators may be very heavily used and waiting times may increase. In the CTU, the amount of construction material and equipment transported with the elevators may be significant, and loading and unloading of the transported construction material and equipment may take some time.

Further, during the CTU, it may be challenging to transport construction material, equipment and people in an efficient and timely manner.

### SUMMARY

According to a first aspect, there is provided an apparatus for construction time use of at least one elevator car of an elevator system. The apparatus comprises a first communication interface configured to provide a connection to at least one local construction site data source, wherein the at least one local construction site data source is configured to track people and/or material flow during the construction time use; a second communication interface configured to provide a connection to at least one site manager application configured to access data provided by the apparatus and to at least one back-end system configured to provide construction project data associated with a construction site. The apparatus is configured to monitor and/or control a construction time use of at least one elevator car based on data obtained via the first communication interface and the second communication interface.

In an implementation form of the first aspect, the at least one back-end system comprises at least one project planning system providing data associated with priority and scheduling of transportable entities.

In an implementation form of the first aspect, the at least one back-end m comprises at least one logistic system providing data associated with tracking material deliveries and supply lines.

In an implementation form of the first aspect, the at least one back-end system comprises at least one tool rental system providing data associated with rental tools associated with the construction project.

In an implementation form of the first aspect, the at least one local construction site data source comprises a transportation entity tracking system comprising a plurality of readers configured to read an identifier associated with transportable entities.

In an implementation form of the first aspect, the apparatus is configured to check, based on the data obtained via the first communication interface and second communication interface, that an elevator car is loaded with correct transportable entities; and issue a notification when the elevator car is not loaded with correct transportable entities.

In an implementation form of the first aspect, the apparatus is configured to make, based on the data obtained via the first communication interface and second communication interface, an automatic elevator call.

In an implementation form of the first aspect, the apparatus is configured to provide a report of a completed delivery with the at least one elevator car.

In an implementation form of the first aspect, the apparatus is configured to prioritize an elevator call based on the data obtained via the first communication interface and second communication interface.

In an implementation form of the first aspect, the apparatus is configured to obtain a request for an elevator call from a mobile device via the second communication interface; and allocate the elevator call based on the request.

In an implementation form of the first aspect, the apparatus is configured to obtain a tracking request of a transportable entity via the second communication interface; determine a location of the transportable entity based on data from the at least one local construction site data source; and provide the location of the transportable entity via the second communication interface.

In an implementation form of the first aspect, the apparatus is configured to obtain an order of at least one transportable entity via the second communication interface; determine data associated with the order from at least one of at least one back-end system and at least one local construction site data source; and make an elevator call based on the determination.

According to a second aspect, there is provided a construction time use elevator system comprising an apparatus of the first aspect; and at least one local source connected to the construction site data apparatus.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a block diagram of an apparatus according to an example embodiment.

FIG. 2 illustrates a system according to an example embodiment.

### DETAILED DESCRIPTION

Various examples and embodiments discussed herein disclose a solution in which an apparatus, for example, a site controller for constructions site use (CTU) may be arranged in an elevator system. The site controller may be configured to control and/or monitor a construction time use of at least one elevator car of the elevator system. The site controller may comprise a first communication interface configured to provide a connection to at least one local construction site data source, wherein the at least one local construction site data source is configured to track people and/or material flow during the construction time use. The site controller may further comprise a second communication interface configured to provide a connection to at least one site manager application configured to access data provided by the site controller and to at least one back-end system configured to provide construction project data associated with a construction site. The site controller may be configured to monitor and/or control a construction time use of at least one elevator car based on data obtained via the first communication interface and the second communication interface.

A term “transportable entity” used herein may refer to any object, for example, a specific material, a batch of material, tool or a person, transported during the CTU using the at least one elevator car.

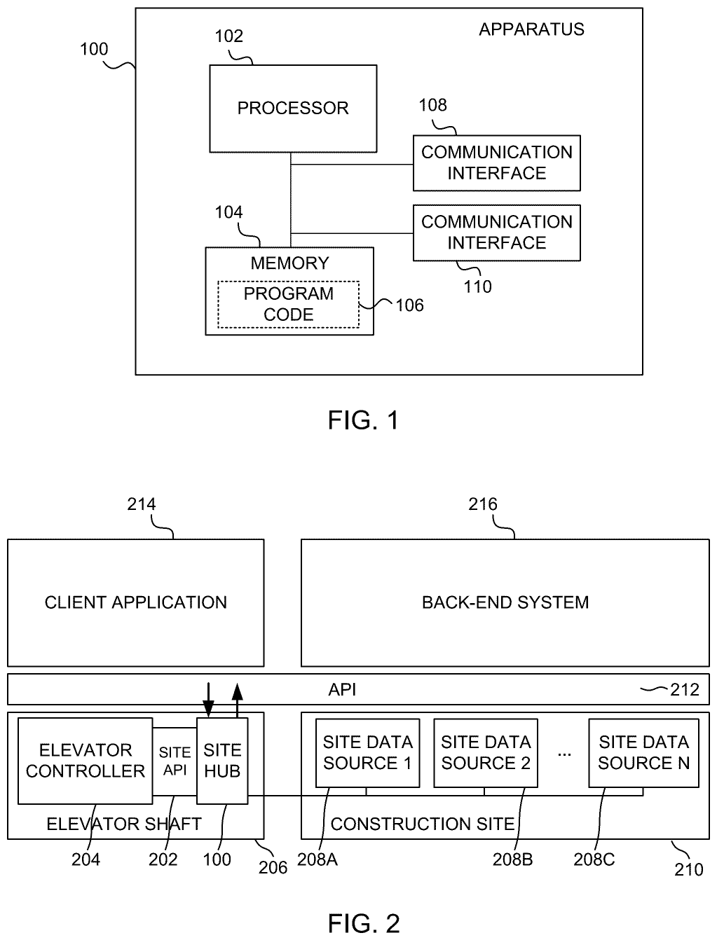

FIG. 1 illustrates a block diagram of an apparatus 100 according to an example embodiment. The apparatus 100 may be, for example, a computer or a server computer, and it may be configured to implement the functions of a site controller. In an example embodiment, the apparatus 100 may be integrated to be part of an elevator controller, an elevator group controller or an elevator drive as a separate circuit board/module or as an integrated hardware. In another example embodiment, the apparatus 100 may be implemented, for example, with an additional software module in the elevator controller, elevator group controller or elevator drive. In other words, the apparatus 100 may refer, for example, to an elevator controller, an elevator group controller or an elevator drive that is configured to implement the discussed features.

The apparatus 100 comprises one or more processors 102, and one or more memories 104 that comprise computer program code. The apparatus 100 may also include a first communication interface 108 and a second communication interface 110. Although the apparatus 100 is depicted to include only one processor 102, the apparatus 100 may include more than one processor. In an example embodiment, the memory 104 is capable of storing instructions, such as an operating system and/or various applications.

Furthermore, the processor 102 is capable of executing the stored instructions. In an example embodiment, the processor 102 may be embodied as a multi-core processor, a single core processor, or a combination of one or more multi-core processors and one or more single core processors. For example, the processor 102 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 102 may be configured to execute hard-coded functionality. In an example embodiment, the processor 102 is embodied as an executor of software instructions, wherein the instructions may specifically configure the processor 102 to perform the algorithms and/or operations described herein when the instructions are executed.

The memory 104 may be embodied as one or more volatile memory devices, one or more non-volatile memory devices, and/or a combination of one or more volatile memory devices and non-volatile memory devices. For example, the memory 104 may be embodied as semiconductor memories (such as mask ROM, PROM (programmable ROM), EPROM (erasable PROM), flash ROM, RAM (random access memory), etc.).

In an embodiment, the at least one memory 104 may store program instructions 106 that, when executed by the at least one processor 102, cause the apparatus 100 to perform the functionality of the various embodiments discussed herein. Further, in an embodiment, at least one of the processor 102 and the memory 104 may constitute means for implementing the discussed functionality.

FIG. 2 illustrates a system according to an example embodiment. The system illustrated in FIG. 2 may be applied, for example, during a construction time use (CTU).

The system comprises a site controller 100 (or a site hub) which may be connected to an elevator controller 204 via a site application programming interface (API) 202. This enables the site controller 100 to provide instructions to the elevator controller 204, for example, to allocate elevator calls. In another example embodiment, the functions of the site controller 100 may be implemented by the elevator controller 204, an elevator group controller or an elevator drive and thus no API 202 and separate site controller 100 are needed. The site controller 100 in general may refer to an entity that is configured to enable an access or a connection to a variety of different system elements.

The site controller 100 may comprise a first communication interface configured to provide a connection to at least one local construction site data source 208A, 208B, 208C, wherein the at least one local construction site data source is configured to track people and/or material flow during the construction time use. In an example embodiment, one or more construction site data sources may be configured to track people flow and one or more construction site data sources may be configured to track material flow. In an example embodiment, one or more construction site data sources may be configured to track both the people flow and the material flow. The connection to the at least one local construction site data source 208A, 208B, 208C may be implemented, for example, using at least one the following techniques: a Wi-Fi connection, a physical Ethernet connection or an IoT mesh connection depending on the location. The Wi-Fi connection may be used, for example, when high data throughput is needed. The LOT mesh connection may be used, for example, for small, cheap and/or battery powered devices that do not send much data.

In general, the at least one local construction site data source 208A, 208B, 208C may refer to external sensors, automated systems and/or data sources that store and provide information about which tools, materials and people (i.e. transportable entities) are about to be, or are currently being transported in the elevator. Different site data may be arranged in a single data source, for example, a database, or in multiple data sources. Any appropriate tracking and/or identification system may be used to track and/or identify the tools, material and people, for example, frequency Bluetooth, radio identification (RFID) applying RFID tags, wireless positioning etc. The local construction site data source 208A, 208B, 208C and/or back-end systems 216 may comprise identification information associated with each transportable entity. The Identification information may be stored, for example, in a remotely readable device or tag, for example, a radio frequency identification (RFID) tag, attached to or otherwise associated with a transportable entity. The construction site may then comprise one or more readers that are able to remotely read the identification information, when the corresponding transportable entity is loaded/unloaded to/from an elevator. The readers may be arranged in the elevators or outside the elevators at appropriate locations.

In an example embodiment, the at least one local construction site data source 208A, 208B, 208C may comprise one or more of the following:
a material and waste tracking system
a people location and identification system
an asset location and usage rate management system
a site condition monitoring system.

The material and waste tracking system may provide information, for example, where material and/or tools are being located, and how much waste is accumulated during the construction phase. The people location and identification system may provide information, for example, on personnel location and identity of the personnel at the location. The asset location and usage rate management system may provide information, for example, on one or more assets that can be used in the construction site and their associated location. An asset may refer, for example, to a material, a tool, an employee etc. The asset location and usage rate management system may also track usage rate of the one or more assets, for example, when, where and/or how long an asset was used during the construction phase, where and/or how long a specific employee has worked in the constructions site during the construction phase etc. This may then provide management information, for example, to a back-end system 216. The site condition monitoring system may provide information, for example, on a status associated with the construction site. The status may refer, for example, to a degree of readiness of the construction site, safety and health issues (for example, the number of reported accidents, the number of accident-free days), temperature, humidity, particulate matter levels etc.

The site controller may further comprise a second communication interface 212, for example, an application programming interface (API), configured to provide a connection to at least one client application 214 configured to access data provided by the site controller and to at least one back-end system 216 configured to provide construction project data associated with a construction site. The second communication interface 212 enables the site controller 100 to connect to external systems and external systems or clients to connect to the site controller 100. For example, elevator calls may be allocated from a mobile device of a person working at the site. Additionally or alternatively, an elevator call may be scheduled and allocated automatically, for example, by a cloud-based managing entity, for example, the back-end system 216. In general, the back-end system or systems 216 may refer to automated systems and data sources that provide information about costs and/or priority of different materials, tools and people to be transferred with the at least one elevator.

In an example embodiment, the local construction site data sources 208A, 208B, 208B and/or the back-end systems 216 may store information associated with one or more transportable entities. A transportable entity may refer, for example, to at least one of a material, a tool, a batch of material, a person etc. Further, one or more properties may be associated with a transportable entity and may be known beforehand, for example, a weight, dimensions, a priority, a time window when the transportable entity is needed at a specific location, a destination floor, an identifier etc. Different transportable entities may have different priorities. In other words, the local construction site data sources 208A, 208B, 208B and/or the back-end systems 216 may include any information that somehow characterizes a transportable entity. Then, based on the information stored in the site data sources 208A, 208B, 208B and/or the back-end systems 216, the site controller 100 may be able to optimize the use of the elevators during the CTU.

In an example embodiment, the client application 214 may be executed in a device, for example, a mobile device of a user. The client application 214 may be used, for example, to place elevator calls, track material, tools and/or people.

In an example embodiment, the back-end system 216 may refer to one or more external project planning systems from which data indicating where items should be going may be obtained. The project planning system may comprise, for example, a cloud based construction project planning tool providing APIs to read data to other systems.

In an example embodiment, the back-end system 216 may refer to one or more logistics systems to obtain identification information of different materials, for example, to cloud based systems for tracking material deliveries and supply lines. The logistics systems may provide APIs to access logistics information that can be used by the site controller 100 for decision making.

In an example embodiment, the back-end system 216 may refer to one or more tool rental systems to obtain information of what kind of tools are being used, how they are used, and for what work tasks they are used during the CTU. The tool rental systems may refer to cloud based systems providing APIs with tool rental information that can be used by the site controller 100 for decision making.

In an example embodiment, the site controller 100 may be configured to check, based on the data obtained via the first communication interface and second communication interface, that an elevator is loaded with correct transportable entities, and issue a notification when the elevator is not loaded with correct transportable entities. The construction site may comprise one or more readers that are able to remotely read identification information associated with the the corresponding transportable entities, when transportable entity is loaded to an elevator. The readers may be arranged in the elevators or outside the elevators at appropriate locations. By combining information from both back-end systems 216 and the site data sources 208A, 208B, 208C, the site controller 100 is able to check that the elevator is loaded with correct contents. In an example embodiment, a notification may be given if something is missing or there is something extra loaded in the elevator car. The site controller 100 may compare what has been loaded into the elevator car (for example, based on RFID data) to what should be in the elevator car (information obtained from the back-end systems 216). If there is a discrepancy based on the comparison, the notification may be given, for example, using a screen in the elevator car, a mobile device, a speaker, color lights etc.

In an example embodiment, the site controller 100 may be configured to make, based on the data obtained via the first communication interface 108 and second communication interface 110, an automatic elevator call. The elevator call may be made via the site API 202, for example, as Message Queuing Telemetry Transport (MQTT) messages sent to the elevator controller 204 by the site controller 100.

In an example embodiment, the site controller 100 may be configured to pre-book elevator cars, for example, based on content, volume, weight and/or delivery type information. The site controller 100 may be configured to make an elevator call or calls to the elevator controller 204, and the elevator controller 204 sees the call or calls as normal calls similarly as if they were coming from normal signalization.

In an example embodiment, the site controller 100 may be configured to provide a report of a completed delivery with the at least one elevator. As the site controller 100 is able to check, based on the data obtained via the first communication interface and second communication interface, that an elevator is loaded with correct transportable entities, and as the site controller 100 is connected to the client application 214 and/or back-end systems 216 via the API 212, the site controller 100 is able to make use of the APIs provided by the back-end systems 216 and provide the report to the back-end systems 216 via these APIs.

In an example embodiment, the site controller 100 may be configured to prioritize an elevator call based on the data obtained via the first communication interface 108 and second communication interface 110. The prioritization may be based, for example, on at least one of a logistics plan (indicating, for example, critical deliveries), a user identity, delivery content, content volume and/or weight information, and a delivery type. The site controller 100 may be configured to use a priority call MQTT message to bypass the current call que in the elevator controller 204.

In an example embodiment, the site controller 100 may be configured to obtain a request for an elevator call from a mobile device via the second communication interface 110, and allocate the elevator call based on the request. For example, the site controller 100 may offer the user of the mobile device information originating from the back-end systems 216 and/or site data sources 208A, 208B, 208C, and the user may make an elevator call through the site controller 100 with appropriate tools, material and/or personnel at an appropriate time.

In an example embodiment, the site controller 100 may be configured to obtain a tracking request of a transportable entity via the second communication interface, determine a location of the transportable entity based on data from the at least one local construction site data source 208A, 208B, 208C, and provide the location of the transportable entity via the second communication interface 110. This may enable a solution in which a user may track any object or person in the construction site by using the client application 214.

In an example embodiment, the site controller 100 may be configured to obtain an order of at least one transportable entity second communication interface 110, determine data associated with the order from at least one of at least one back-end system 216 and at least one local construction site data source 208A, 208B, 208C, and make an elevator call based on the determination. The site controller 100 is thus able to combine information from multiple sources in order to make the elevator call.

One or more of the examples and example embodiments discussed above may enable a solution to optimize usage of elevator during the CTU phase. This may be achieved by combining data from multiple data sources (internal and external) and making elevator calls based on this data. Further, one or more of the examples and example embodiments discussed above adds external data sources for the determination of optimization targets for a call queue of an elevator. In the CTU phase, some trips may get higher priorities than others to prevent bottle necks arising during the CTU phase. For example, workers working on critical construction or logistics tasks may be prioritized so the overall work does not get slowed down because materials, tools or workers cannot get timely manner to right floors, thus causing idle time for workers waiting for tools and materials, or colleagues to work with. Minimizing the idle time for workers will result in an optimized construction work, cutting down the time to complete the construction project and saving costs for the construction companies.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An apparatus for construction time use of at least one elevator car of an elevator system, the apparatus comprising:
a first communication interface configured to provide a connection to at least one local construction site data source, wherein the at least one local construction site data source is configured to track people and/or material flow during the construction time use;
a second communication interface configured to provide a connection to
at least one site manager application configured to access data provided by the apparatus, and
at least one back-end system configured to provide construction project data associated with a construction site;
wherein the apparatus is configured to monitor and/or control a construction time use of at least one elevator car based on data obtained via the first communication interface and the second communication interface.

2. The apparatus of claim 1, wherein the at least one back-end system comprises at least one project planning system providing data associated with priority and scheduling of transportable entities.

3. The apparatus of claim 1, wherein the at least one back-end system comprises at least one logistic system providing data associated with tracking material deliveries and supply lines.

4. The apparatus of claim 1, wherein the at least one back-end system comprises at least one tool rental system providing data associated with rental tools associated with the construction project.

5. The apparatus of claim 1, wherein the at least one local construction site data source comprises a transportation entity tracking system comprising a plurality of readers configured to read an identifier associated with transportable entities.

6. The apparatus of claim 1, wherein the apparatus is configured to:
check, based on the data obtained via the first communication interface and second communication interface, that an elevator car is loaded with correct transportable entities; and
issue a notification when the elevator car is not loaded with correct transportable entities.

7. The apparatus of claim 1, wherein the apparatus is configured to:
make, based on the data obtained via the first communication interface and second communication interface, an automatic elevator call.

8. The apparatus of claim 7, wherein the apparatus is configured to:
provide a report of a completed delivery with the at least one elevator car.

9. The apparatus of claim 1, wherein the apparatus is configured to:
prioritize an elevator call based on the data obtained via the first communication interface and second communication interface.

10. The apparatus of claim 1, wherein the apparatus is configured to:
obtain a request for an elevator call from a mobile device via the second communication interface; and
allocate the elevator call based on the request.

11. The apparatus of claim 1, wherein the apparatus is configured to:
obtain a tracking request of a transportable entity via the second communication interface;
determine a location of the transportable entity based on data from the at least one local construction site data source; and
provide the location of the transportable entity via the second communication interface.

12. The apparatus of claim 1, wherein the apparatus is configured to:
obtain an order of at least one transportable entity via the second communication interface;
determine data associated with the order from at least one of at least one back-end system and at least one local construction site data source; and
make an elevator call based on the determination.

13. A construction time use elevator system comprising:
an apparatus of claim 1; and
at least one local construction site data source connected to the apparatus.

14. The apparatus of claim 2, wherein the at least one back-end system comprises at least one logistic system providing data associated with tracking material deliveries and supply lines.

15. The apparatus of claim 2, wherein the at least one back-end system comprises at least one tool rental system providing data associated with rental tools associated with the construction project.

16. The apparatus of claim 3, wherein the at least one back-end system comprises at least one tool rental system providing data associated with rental tools associated with the construction project.

17. The apparatus of claim 2, wherein the at least one local construction site data source comprises a transportation entity tracking system comprising a plurality of readers configured to read an identifier associated with transportable entities.

18. The apparatus of claim 3, wherein the at least one local construction site data source comprises a transportation entity tracking system comprising a plurality of readers configured to read an identifier associated with transportable entities.

19. The apparatus of claim 4, wherein the at least one local construction site data source comprises a transportation entity tracking system comprising a plurality of readers configured to read an identifier associated with transportable entities.

20. The apparatus of claim 2, wherein the apparatus is configured to:
check, based on the data obtained via the first communication interface and second communication interface, that an elevator car is loaded with correct transportable entities; and
issue a notification when the elevator car is not loaded with correct transportable entities.
